(19) United States
(12) Patent Application Publication
(10) Pub. No.: US 2016/0217250 A1
(43) Pub. Date: Jul. 28, 2016

(54) IDENTIFYING MOLECULAR SYSTEMS IN PROTEIN SEQUENCE DATA

(71) Applicants: Institut Pasteur, Paris (FR); Centre National de la Recherche Scientifique (CNRS), Paris (FR)

(72) Inventors: Sophie Saphia ABBY, Grenoble (FR); Bertrand Jean-Luc NERON, Cachan (FR); Eduardo ROCHA, Bures sur Yvette (FR); Marie TOUCHON, Bois-Colombes (FR); Herve MENAGER, Paris (FR)

(21) Appl. No.: 14/606,741

(22) Filed: Jan. 27, 2015

(51) Int. Cl. G06F 19/16; G06F 19/22; C40B 30/02

(52) U.S. Cl. CPC G06F 19/16; C40B 30/02; G06F 19/22

(57) ABSTRACT

Methods for identifying a molecular system that is similar to at least one model molecular system are provided. The methods may comprise a) establishing an inventory including genetic content, genomic organization and at least one discriminating trait for at least one model molecular system; b) determining from the inventory(ies) of step a) a non-redundant list of protein components of the at least one model molecular system; c) associating a protein component profile encoded by a hidden Markov model (HMM) for each non-redundant protein component; d) providing at least one set of protein sequences obtained from genome data corresponding to a contig of an ordered sequence dataset; e) similarity searching the set of protein sequences obtain from genome data with the protein component profiles of c); f) selecting hit proteins that match the searched protein component profiles from among the set of protein sequences obtain from genome data; g) building clusters using hit proteins selected in step f) according to the genomic organization specified for the model molecular system; h) selecting clusters including protein components of a single model molecular system according to the genetic content and discriminating traits specified for the model molecular system; and i) filling inventories of compatible model molecular systems using clusters from step h).

### INTRODUCTION

The present invention relates generally to the field of computational biology and more specifically to the field of functional annotation of genomes by the identification and the characterization of molecular complexes and molecular pathways.

The present invention is also related to the detection and classification of particular molecular systems in the field of microbiology, molecular evolution and comparative genomics.

Biologists often wish to annotate a given function in a large number of divergent DNA or protein sequences. Functional annotation is often performed gene by gene, starting with methods of similarity search. However, complex cellular systems, such as molecular machineries or molecular pathways, are encoded by conserved sets of genes often in specific genetic architectures. The use of this information greatly ameliorates functional annotation, but is hampered by the definition of biologically meaningful models and discrimination between homologous systems.

Molecular systems are involved in key aspects of cell biology (Alberts, Cell 92:291-294, 1998; Pereira-Leal et al., Philos Trans R Soc Lond B Biol Sci 361:507-517). They can be constituted of molecular complexes, like the ribosome or the flagellum, or molecular pathways, like the ones allowing the degradation of foreign genetic elements by CRISPR-Cas systems.

The identification and classification of molecular systems is important to characterize biological traits, and is routinely done in many laboratories. However, it is difficult to do on a systematic basis by a number of reasons.

Firstly, molecular systems are made of many different components with different levels of dispensability, some being essential and others accessory. For example, homologous recombination in bacteria involves some key essential components (like RecA), and several associated alternative pathways (like RecBCD and RecFOR) (Michel et al., Proc Natl Acad Sci USA 101:12783-12788, 2004).

Secondly, key components may have homologs in other molecular systems, complicating their unambiguous assignment to a given molecular system. This is for instance the case of the non-flagellar type III secretion system for which eight of the nine core genes have homologs in the bacterial flagellum (Abby & Rocha, PLoS Genet 8:e1002983, 2012)

Thirdly, the components of the molecular systems evolve at very diverse rates, complicating the identification of homology by sequence similarity. For example, many proteins involved in reproduction are highly conserved, whereas others endure selection for fast evolution (Galagan et al., Genome Res 12:532-542, 2002).

These difficulties can be partly circumvented by searching for the whole set of components of the molecular system because the integration of all the information leads to more accurate inference. This is especially relevant if the genes encoding these components are organized in highly conserved ways. In Prokaryotes, organelles and viruses, molecular systems are often encoded in one or a few conserved neighboring operons ensuring tight regulation and correct assembly/functioning. This facilitates the assignment of certain components to a molecular system (Huynen et al., Genome Res 10:1204-1210, 2000; Overbeek et al., Proc Natl Acad Sci USA 96:2896-2901, 1999; Lathe et al., Trends Biochem Sci 25:474-479, 2000; Zaslaver et al., Phys Biol 3:183-189, 2006).

Nonetheless, there is a need in the art for new and improved methods for identifying molecular systems in genome data.

### SUMMARY

The inventors provide in the present invention a flexible method and a computer program for an efficient annotation of molecular systems in genomes.

The present invention relates to a method to model properties of molecular systems including their protein components, evolutionary associations with other systems and genetic architecture. In some embodiments of the present invention, modelled features also include functional analogs and the multiple uses of a same component by different molecular systems.

Model molecular systems are used to search for molecular systems in completes genomes or in unstructured data like metagenomes. The protein components of the model molecular systems are searched by sequence similarity using protein component profiles. The assignment of hit proteins to a given model molecular system is decided based on compliance with the content and organization of the model molecular system.

In some embodiments of the present invention, a graphical interface facilitates the analysis of the results by showing overviews of protein component content and genomic context.

An aspect of the invention is a method for identifying a molecular system that is similar to at least one model molecular system, the method comprising the steps of: a) establishing an inventory including genetic content, genomic organization and at least one discriminating trait for at least one model molecular system; b) determining from the inventory(ies) of step a) a non-redundant list of protein components of the at least one model molecular system; c) associating a protein component profile encoded by a hidden Markov model (HMM) with each non-redundant protein component; d) providing at least one set of protein sequences obtained from genome data corresponding to a contig of an ordered sequence dataset; e) similarity searching the set of protein sequences obtain from genome data with the protein component profiles of c); f) selecting hit proteins that match the searched protein component profiles from among the set of protein sequences obtained from genome data; g) building clusters using hit proteins selected in step f) according to the genomic organization specified for the model molecular system; h) selecting clusters including protein components of a single model molecular system according to the genetic content and discriminating traits specified for the model molecular system; and i) filling inventories of compatible model molecular systems using clusters from step h).

In some embodiments the method further comprises the step of visualizing the similar molecular system detected.

In some embodiments the genome data come from a bacterium, an archaeum, an organelle or a virus.

In some embodiments at least one set of protein sequences is a set of multiple ordered contigs which organism of origin is identifiable with predefined naming convention of the sequence.

In some embodiments the at least one discriminating trait is a class of protein components. In some embodiments at least one protein component is defined as mandatory. In some embodiments the at least one discriminating trait is a model molecular system quorum corresponding to a minimal number of mandatory protein components required in a model molecular system. In some embodiments a model molecular system is fully detected when the required quorum is respected. In some embodiments at least one protein component is defined as accessory. In some embodiments at least one protein component is defined as forbidden.

In some embodiments the at least one discriminating trait is a protein component attribute. In some embodiments at least one protein component is defined as exchangeable. In some embodiments at least one protein component is defined as multi-system.

In some embodiments the at least one discriminating trait is a model molecular system quorum. In some embodiments the model molecular system quorum corresponds to the maximal number of protein components required. In some embodiments a model molecular system is fully detected when the required quorum is respected.

In some embodiments the at least one discriminating trait is a class of protein components. In some embodiments the at least one discriminating trait is a model molecular system quorum corresponding to a minimal number of protein components required. In some embodiments a model molecular system is fully detected when the required quorum is respected.

In some embodiments the at least one discriminating trait is a genomic organization attribute. In some embodiments at least one protein component is defined as loner. In some embodiments at least one model molecular system is defined as multi-loci. In some embodiments a single cluster is not enough to make a complete model molecular system, and further comprising the steps of: j) storing hits of the cluster; and k) filling inventories of model molecular systems defined as multi-loci.

In some embodiments the genomic organization of the model molecular system is defined by an integer representing the maximal number of protein components without a match between two hits of a cluster. In some embodiments the similarity searching of step e) is performed with Hmmer. In some embodiments the similarity searching of each of a plurality of sets of protein sequences obtained from genome data is performed in parallel.

In some embodiments step f) comprises applying selection criteria to the selected hit proteins to identify hit proteins with the highest similarity to the protein component profiles.

In some embodiments multiple model molecular system candidates are compatible with the set of protein components of a cluster, and further comprising the steps of: j) classifying model molecular system candidates by decreasing number of protein components shared between the cluster and the compatible model molecular system candidates; and k) assigning the cluster to the first model molecular system candidate in the list fitting its content.

In some embodiments a model molecular system has protein components from a single locus and, further new occurrences of the same protein components in a cluster are used to produce a novel molecular system.

In some embodiments clusters with protein components from multiple model molecular systems are split-up in sub-clusters containing protein components from a single model molecular system and are re-analyzed in terms of their protein components.

In another aspect the invention provides a computer-readable storage medium storing instructions of a computer program for implementing a method of the invention disclosed herein.

### BRIEF DESCRIPTION OF THE DRAWINGS

FIG. 1 illustrates an embodiment of implementation of a method of the present invention with an object-oriented architecture.

FIG. 2: Modeling systems with MacSyFinder. The components of a molecular system assemble into molecular complexes or correspond to a biological pathway. They are typically encoded in genomes in one or a few different loci (“Genomic context”). We illustrate the molecular system modeling with two imaginary systems “A” and “B” that have four homologous protein components (C1-C4, similar colors for the two molecular systems), which we want to distinguish. The system “B” has one protein component that is not found in “A” (C5). The parameter inter_gene_max_space (D) defines the maximal number of genes between two consecutive protein component genes (di,j). The two model molecular systems are defined by a set of mandatory (green), accessory (black) and forbidden (red) protein components. The quorum rules allow relaxing the definition of the model molecular system without altering the list of its protein components (min_genes_required and min_mandatory_genes_required parameters in XML files). They can either be defined by the user in the XML file or in the command-line. If they are not specified, a default value is computed from the number of protein components described in the XML files. The bottom part of the figure shows the description of the molecular systems in the XML grammar. Protein components listed here refer to protein component profiles (FIG. 3). When a protein component is found in several model molecular systems, it is defined only once, and can be reused in another model molecular system with the system_ref keyword. Much more complex features can be defined, including exchangeable protein component genes, distant protein component genes and protein component-specific parameters.

FIGS. 3A and 3B: Functioning of MacSyFinder. A: The user launches MacSyFinder to detect molecular systems A and B (example of FIG. 2). System-specific parameters are read from the corresponding XML definition files. This includes the list of the protein components of the model molecular systems and the corresponding HMM profiles. Other detection parameters are picked by order of priority: on the command-line, in the configuration file, and in the XML files. Sequences are indexed with the “formatdb” or “makeblastdb” tools for similarity search with the Hmmer program. MacSyFinder runs (optionally in parallel) the Hmmer searches on a non-redundant list of protein components' profiles. If the protein sequence dataset is “unordered” MacSyFinder only outputs the hits and the protein components detected for each type of model molecular system. B: Step #1: The co-localization criterion can be used in the ordered protein datasets. It involves clustering the hits separated by less than D protein component-coding genes. The protein components described as “loner” in the XML definition files can be at any distance from other protein components. Step #2: the protein components of each cluster are used to fill the occurrences of the model molecular systems. Depending on the quorum, a cluster can describe a “full” model molecular system, or a “scattered” model molecular system. Step #3: clusters with protein components belonging to more than one model molecular system are split to unique model molecular systems and then re-directed separately to step #2.

FIG. 4: Simplified operon organization of the three major types and ten subtypes of CRISPR-Cas systems. Each cas gene family is indicated with a distinct color, those specific to a subtype are in white. Only the main cas gene families are represented.

FIGS. 5A-5D: Genomic architecture and taxonomic distribution of detected cas genes clusters (general model). A. Distribution of the number of different genes in detected clusters. B. Distribution of the maximal distance between two protein component genes observed in each detected cluster. C. Boxplot of the number of different protein component genes in each cluster vs. the maximal distance between two protein components genes observed in each cluster. D. Proportion of bacterial and archaeal genomes without (cluster−) and with at least one cluster of cas genes (cluster+).

FIGS. 6A-6H: Frequency of co-occurrence between Cas proteins present in clusters detected with the general model (left) and the subtyping models (right). Each matrix was normalized by the maximum of each column. The higher the frequency is, the warmer the color is: the red diagonal corresponds to a 100% co-occurrence. Only frequencies above 1% were represented, others are in grey.

### DETAILED DESCRIPTION

### A. Definitions

The following terms, and the theoretical aspects of the present invention which they convey, are generally accepted by those skilled in the art. They are summarized here for the sake of clarity.

As used herein “analogous systems” are two molecular systems similar due to convergent evolution.

As used herein a “cluster” is a set of components that lie aside in a contig, according to a component-wise proximity parameter.

As used herein a “contig” is a set of genome data structured in the order it is found in a chromosome.

As used herein “genetic content” is an inventory of genes.

As used herein “genome data” is a set of DNA and/or protein sequences of an organism(s), represented as at least one text string.

As used herein a “hit” is a sequence present in genomic data that is a positive match to a model sequence for a given search threshold.

As used herein a “hit protein” is a protein having a hit sequence.

As used herein “HMM” is an abbreviation for the hidden Markov model.

As used herein “homologous systems” are two similar molecular systems inherited by two different organisms from a common ancestor.

As used herein a “model molecular system” is a formal description of a molecular system allowing its detection.

As used herein a “molecular system” is a set of components involved in a particular biological function.

As used herein a “molecular complex” is a molecular system whose components physically interact and assemble to perform the function.

As used herein a “molecular pathway” is a molecular system whose components are successively involved to complete the same function.

As used herein a “protein component” is a protein that is an element of a model molecular system.

### B. General Aspects

In the field of functional annotation of genomes, the search for the whole set of components of a molecular system is more efficient than the search for individual components because the integration of all the information leads to more accurate inference. According to a first aspect of the invention there is providing a molecular system that is similar (e.g., analogous or homologous) to at least one model molecular system. In some embodiments the methods comprise the steps of: a) establishing an inventory including genetic content, genomic organization and at least one discriminating trait for at least one model molecular system; b) determining from the inventory(ies) of step a) a non-redundant list of protein components of the at least one model molecular system; c) associating a protein component profile encoded by a hidden Markov model (HMM) with each non-redundant protein component; d) providing at least one set of protein sequences obtained from genome data corresponding to a contig of an ordered sequence dataset; e) similarity searching the set of protein sequences obtain from genome data with the protein component profiles of c); f) selecting hit proteins that match the searched protein component profiles from among the set of protein sequences obtained from genome data; g) building clusters using hit proteins selected in step f) according to the genomic organization specified for the model molecular system; h) selecting clusters including protein components of a single model molecular system according to the genetic content and discriminating traits specified for the model molecular system; and i) filling inventories of compatible model molecular systems using clusters from step h).

In some embodiments, in step a) an inventory including genetic content, genomic organization and at least one discriminating trait is established for each of a plurality of model molecular systems; and in step b) a non-redundant list of protein components is determined from the plurality of inventories.

In some embodiments a plurality of molecular systems are identified that are homologous or analogous (i.e., similar) to the at least one model molecular system.

In some embodiments two molecular systems are similar. In some embodiments the similar molecular systems are homologous molecular systems. In some embodiments the similar molecular systems are analogous molecular systems.

HMM protein profiles have the advantage, relative to pairwise alignments with a reference expert database, of providing a compressed way to represent a database of homologous sequences, resulting in increased sensitivity and specificity (Eddy, PLoS Comput Biol 7:e1002195, 2011). These protein profiles are also more stable over time. Protein profiles can be built with the Hmmer software (Eddy, PLoS Comput Biol 7:e1002195, 2011) on multiple alignments of relevant homologous proteins. When available, these protein profiles can also be retrieved from public databases such as PFAM or TIGRFAM (Finn et al., Nucleic Acids Res 36:D281-288, 2008; Haft et al., Nucleic Acids Res 29:41-43, 2001).

In some embodiments of the present invention, the method further comprises the step of visualizing the analogous or homologous molecular systems detected. A graphical interface provides the advantage to facilitate the analysis of the results by showing overviews of component content and genomic context.

Since the present invention is a generic method, it flexibly adapts to both the detection of molecular complexes and molecular pathways. Therefore, in some embodiments of the present invention, a model molecular system is a molecular complex. In other embodiments of the present invention, a model molecular system is a molecular pathway. In some embodiments at least one molecular complex and at least one molecular pathway are searched in the same method.

### C. Inventories

The methods of the present invention allow production of models of molecular systems integrating the type and number of protein components, their genetic organization, their colocalization and their relations of homology and/or functional analogy with other protein components. Such criteria proved to be highly relevant for wide-scale analyses of prokaryotes that resulted in significant biological insights (Abby & Rocha, PLoS Genet 8:e1002983, 2012; Guglielmini et al., Mol Biol Evol. 30(2):315-331, 2013).

In some embodiments of the present invention, a discriminating trait is a class of protein components. Classes of protein components are related to the presence or the absence of a protein component in a model molecular system. In other embodiments of the present invention, at least one protein component is defined as mandatory. In this case, the protein component is ubiquitous. In yet other embodiments of the present invention, at least one protein component is defined as accessory. These accessory protein components can be essential for the assembly and/or the functioning of a molecular system, while not being identifiable by sequence similarity because of rapid evolution. In still further embodiments of the present invention, at least one protein component is defined as forbidden. Discrimination between partly homologous molecular systems may be facilitated when at least one protein component is defined as forbidden in the model molecular system lacking them.

The inclusion in the inventory of information about homologous model molecular systems avoids the misidentifications of homologous and analogous molecular systems. In some embodiments of the present invention, a discriminating trait is a protein component attribute. Protein component attributes are related to evolutionary aspects of the presence or the absence of protein components in model molecular systems. In other embodiments of the present invention, at least one protein component is defined as exchangeable. In this case, the component or one of its homologs or analogs can be interchanged for the assessment of the presence of the model molecular system in a genome. In yet other embodiments of the present invention, at least one protein component is defined as multi-system. In this case, the protein component can be used to fill multiple model molecular systems occurrences. As a non-limiting example, it may concern proteins interacting with different instances of a molecular system.

In some embodiments of the present invention, a discriminating trait is a model molecular system quorum. In other embodiments of the present invention, a discriminating trait is a model molecular system quorum corresponding to a minimal number of protein components required for system assessment. As a non-limiting example, the minimal number of protein component corresponds to the minimal number of both mandatory and accessory protein components in a model molecular system. In yet other embodiments of the present invention, a model molecular system quorum corresponds to the maximal number of protein components allowed in the system. In still further embodiments of the present invention, a discriminating trait is a model molecular system quorum corresponding to a minimal number of mandatory protein components required in a model molecular system.

In some embodiments of the present invention, model molecular systems are classified in different levels.

### D. Genome Data

In some embodiments of the present invention, a set of protein sequences is in the form of an unordered sequence dataset. In other embodiments of the present invention, an unordered sequence dataset is an unordered dataset lacking information on gene order and genomic origin. These embodiments are useful to study large sequence databanks or metagenomics data. In yet other embodiments of the present invention, an unordered sequence dataset is an unordered set of protein sequences from one single genome. These embodiments are useful to analyze unassembled genomes. In this case, the notion of quorum is relevant but co-localization is not. In specific embodiments of the present invention, information on forbidden protein components are ignored.

In some embodiments of the present invention, a set of protein sequences corresponds to a contig under the form of an ordered sequence dataset. In this case, proteins from one single contig are ordered according to the position of the corresponding genes in the genome. In other embodiments of the present invention, an ordered sequence dataset is under the form of a set of multiple ordered contigs which organism of origin is identifiable with predefined naming convention of the sequence. It allows the analysis of multiple ordered contigs in a single step. In yet other embodiments of the present invention, the topology of a contig is linear. In still further embodiments of the present invention, the topology of a contig is circular.

### E. Similarity Search

In some embodiments of the present invention, similarity search is performed with Hmmer. The limiting step of the method regarding running time is usually the identification of hits by Hmmer, which is currently very efficient (Eddy, PLoS Comput Biol 7:e1002195, 2011). In other embodiments of the present invention, similarity search of the protein components are performed in parallel in order to speed up the computation and the analysis of Hmmer hits. This can be very useful when analyzing large protein datasets on multi-cores computers.

In some embodiments of the present invention, hit extraction is performed according to user defined maximal e-value search. This value corresponds to the maximal e-value for hits to be reported during Hmmer search. In some embodiments it is set to 1.

In some embodiments of the present invention, hit selection is performed according to user-defined maximal independent i-evalue and minimal profile sequence coverage of the alignment between a protein sequence and a protein component profile. The i-evalue corresponds to the maximal independent e-value for Hmmer hits to be selected for system detection. In some embodiments it is set to 0.001. In some embodiments the value of the minimal profile coverage of the alignment is set to 0.5.

### F. Filling Inventories

In the absence of genomic context information, protein components cannot be individually assigned to a particular model molecular system, the analysis of the number of identified protein components can be used to estimate the number of molecular system instances in the dataset. Therefore, in some embodiments of the present invention, a single model molecular system instance is filled per model molecular system and protein sequence dataset, independently of the number of protein component occurrences found. In some embodiments of the present invention, a model molecular system is fully detected when the required quorum is respected. In some other embodiments of the present invention, protein components defined as functionally exchangeable are only counted once in the quorum.

### G. Genomic Organization Information

An innovation of certain embodiments of the present invention is the use of genomic organization information to identify analogous or homologous molecular systems of one or several model molecular systems in ordered genome data. In some embodiments of the present invention, a genome data come from a bacterium, an archaeum, an organelle or a virus. In these genomes, genes encoding protein components are organized in highly conserved ways and molecular systems are often encoded in one or a few conserved neighboring operons ensuring tight regulation and correct assembly/functioning of a molecular system. This facilitates the assignment of certain protein components to a model molecular system. In further embodiments of the present invention set of protein sequences corresponds to a contig under the form of an ordered sequence dataset.

Theses embodiments are powerful to identify analogous and homologous molecular systems in genomes.

In some specific embodiments of the present invention, a discriminating trait is a genomic organization attribute. In other specific embodiments of the present invention, at least one protein component is defined as loner. In this case, the gene can be isolated on the genome. In yet other specific embodiments of the present invention, at least one model molecular system is defined as multi-loci. In this case, it is possible to detect molecular systems encoded by several distant clusters of genes. In still further specific embodiments of the present invention, the genomic organization of a model molecular system is defined by an integer representing the maximal number of protein components without a match between two hits of a cluster.

In some specific embodiments of the present invention, multiple model molecular system candidates are compatible with the set of protein components of a cluster. In this case, the method further comprises the steps of:

j) classifying model molecular system candidates by decreasing number of protein components shared between the cluster and the compatible model molecular system candidates; and

k) assigning the cluster to the first model molecular system candidate in the list fitting its content.

In some specific embodiments of the present invention, a model molecular system has protein components from a single locus. In this case, new occurrences of the same protein components in a cluster are used to produce a novel molecular system.

In some specific embodiments of the present invention, a single cluster is not enough to make a complete model molecular system. In this case, the method of the present invention further comprises the steps of:

j) storing hits of the cluster; and

k) filling inventories of model molecular systems defined as multi-loci.

In some specific embodiments of the present invention, clusters with protein components from multiple model molecular systems are split-up in sub-clusters containing protein components from a single model molecular system. In this case, sub-clusters are re-analyzed in terms of their protein components.

A second aspect of the present invention provides a computer-readable storage medium storing instructions of a computer program for implementing the method of the present invention.

### Example

### MacSyFinder

We have developed a program named Macromolecular system Finder (MacSyFinder) to detect molecular systems in genome data from user-defined biological models using methods of the invention. These models include information of the system genetic content, organization, and discriminating traits. We implemented the framework as a generic customizable tool that is portable and can be installed in-house for large genomic or metagenomic projects. A companion program, MacSyView, allows visualizing detected systems in a web browser, while not requiring sending data online. To show a typical situation where MacSyFinder can be useful, we built a set of models to identify Cas proteins from CRISPR-Cas systems. These proteins have been subject to high interest in the recent years [10,11] and no available programs allow detecting and classing them. This example shows that using information from the literature and available protein profiles, one can easily build an accurate and efficient “Cas-finder” with MacSyFinder.

Materials and Methods

Object-Oriented Implementation

MacSyFinder was coded in Python using object-oriented programming. The main classes are described in this section and a full description of the API is provided in the documentation. The System class models the molecular systems and contains a list of instances of the Gene class, which models each protein component of a given System. The Homolog class (resp. Analog) encapsulates a Gene and models relationships of homology (resp. analogy) between protein components. Gene refers to an instance of the Profile object that corresponds to an HMM profile that is used for similarity search purpose. The Config class handles the program parameters, including Hmmer search parameters, and the set of sequences to query (represented by the Database object). The Database stores information on the protein dataset, including necessary information to detect model molecular systems in both linear and circular chromosomes, and when suitable, data for graphical representation of System instances in their genomic context. A set of parsers and object factories are used to fill the objects from command-line and input files (i.e., the optional configuration file and the XML files describing the systems), and to ensure their uniqueness and integrity. Once these objects are initialized and the detection is launched, Hmmer is executed on the protein sequences of the database (optionally in parallel) with a unique list of protein component profiles corresponding to the model molecular systems to detect. Subsequently, Hmmer output files are parsed, and selected hits (given the search parameters provided) are used to fill Hit objects, which contain information for the detection of the model molecular systems. During the treatment of the Hits for Systems detection, the occurrences of the model molecular systems (SystemOccurence objects) are filled, and the decision rules associated with the model molecular systems (quorum and co-localization) are applied.

Dependencies

MacSyFinder has two dependencies: it requires the formatdb or makeblastdb tools (version 2.2.28 or better for the latter) [NCBI {BLAST}executablesdownload (includes formatdb). \url{ftp://ftp.ncbi.nih.gov/blast/executables/LATEST/}; Camacho C, Coulouris G, Avagyan V, Ma N, Papadopoulos J, et al. (2009) BLAST+: architecture and applications. BMC Bioinformatics 10: 421] and the program Hmmer [Eddy S R (2011) Accelerated Profile HMM Searches. PLoS Comput Biol 7: e1002195; Eddy S R (1998) Profile hidden Markov models. Bioinformatics 14: 755-763]. Python version 2.7 is required to run MacSyFinder. MacSyFinder is freely available with its source code under a GPLv3 license at https://github.com/gem-pasteur/macsyfinder (updates follow-up). It is compatible with all platforms supporting Python, Hmmer, and makeblastdb. MacSyView's source code is freely available at https://github.com/gem-pasteur/macsyview but it is also distributed in MacSyFinder's package. MacSyView was coded in Javascript and uses third-party libraries that are all accredited in the COPYRIGHT file distributed with the MacSyFinder/MacSyView package. It includes among others the Raphael library for systems drawing, the Bootstrap library for HTML design and the Mustache library for HTML templating in Javascript. It was tested on Chromium and Firefox for Linux, and on Chrome, Firefox and Safari for Mac OS X. A documentation file including installation and users' instructions, details on modeling procedures and examples for MacSyView and MacSyFinder are available.

Data

The complete genomes of bacteria (2484) and archaea (159) were downloaded from NCBI RefSeq (ftp://ftp.ncbi.nih.gov/genomes/, November 2013). Hidden Markov model protein profiles (HMMs) related to Cas protein families were obtained from the TIGRFAM database, version 13.0 (http://www.jcvi.org/cgi-bin/tigrfams/index.cgi, Aug. 15 2012). Among the 89 HMMs available, 53 were constructed by Haft and colleagues [Haft D H, Selengut J, Mongodin E F, Nelson K E (2005) A guild of 45 CRISPR-associated (Cas) protein families and multiple CRISPR/Cas subtypes exist in prokaryotic genomes. PLoS Comput Biol 1: e60.] and correspond to 45 Cas protein families that were used to propose a CRISPR-Cas systems classification [Makarova K S, Haft D H, Barrangou R, Brouns S J, Charpentier E, et al. (2011) Evolution and classification of the CRISPR-Cas systems. Nat Rev Microbiol 9: 467-477]. Subsequent to this original publication, they have recently constructed 36 additional HMMs profiles more specific to given subtypes. We renamed these profiles to make them more informative for the user.

CRISPR-Cas Type and Subtype Assignment: Command-Lines

The command-lines below were used to run the analyses described in the Application section (“all” means that all systems defined in the definition folders will be searched). In these commands “CASprofiles” is the directory containing the protein profiles. “DEF-General”, “DEF-Typing” and “DEF-SubTyping” are the directories containing respectively the system models for the General, Typing, and Subtyping levels of classification.

General Model:

macsyfinder -w 20 -d DEF-General/ -p CASprofiles/ --db-type gembase --
sequence-db alltogether.prot --topology-file alltogether.topology all

Typical Modes:

macsyfinder -w 20 -d DEF-Typing/ -p CASprofiles/ --db-type gembase --
sequence-db alltogether.prot --topology-file alltogether.topology all

Subtyping Models:

macsyfinder -w 20 -d DEF-SubTyping/ -p CASprofiles/ --db-type gembase
-- sequence-db alltogether.prot --topology-file alltogether.topology all

MacSyFinder's Rationale

Definition of the Models

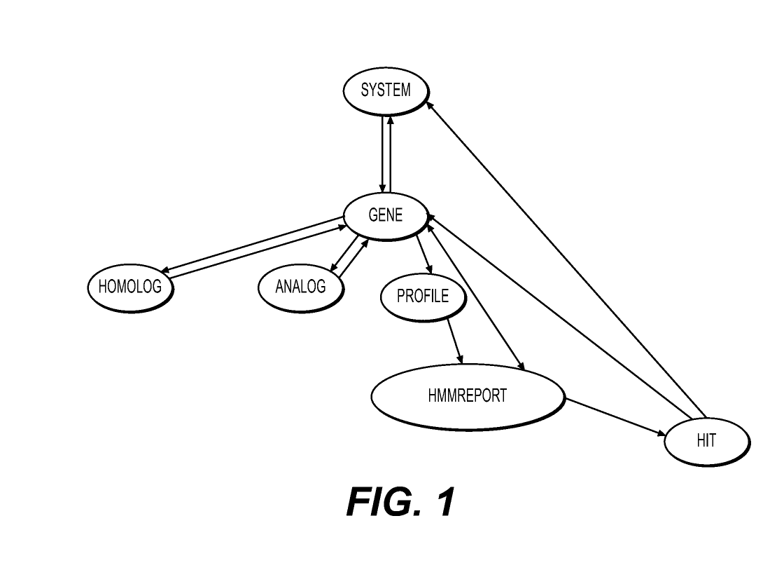

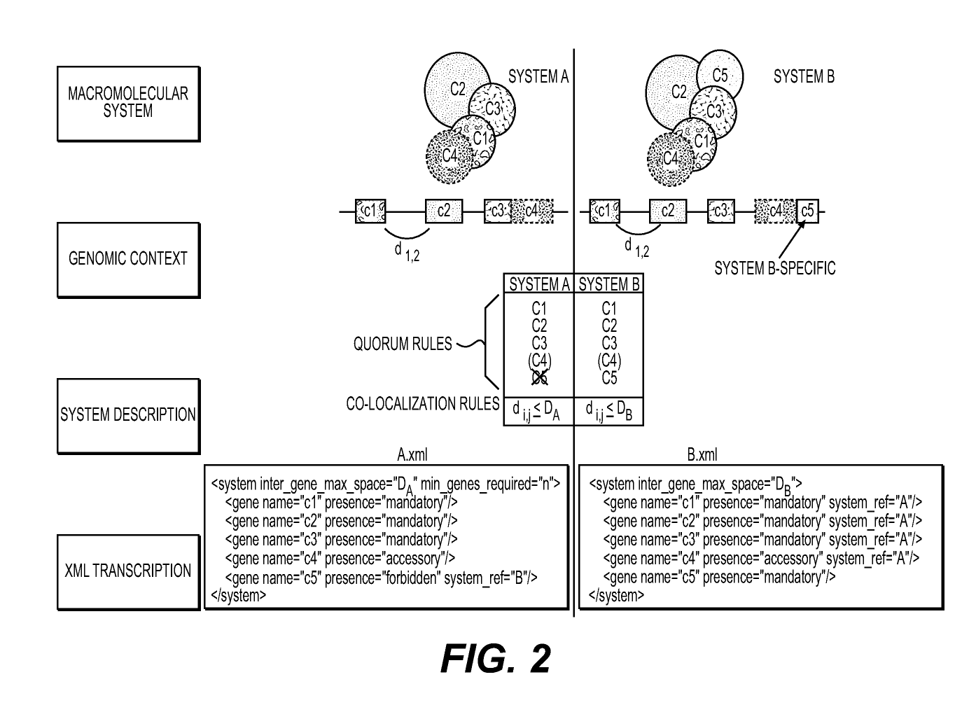

MacSyFinder models, written using an XML grammar, describe the protein components and genetic organization of a given molecular system (see the documentation in File 51 for a full description of the grammar). Each model is defined in a dedicated file named after the type of system (e. g., ‘CAS-TypeI.xml’), which contains system-wise and component-wise features (FIG. 1). MacSyFinder considers three classes of protein components: mandatory, accessory, and forbidden. Protein components that are ubiquitous (i.e., identifiable in all molecular systems) are defined as mandatory. Other protein components of the model molecular system are defined as accessory. These accessory protein components can be essential for the assembly/functioning of the molecular system, while not being identifiable by sequence similarity because of rapid evolution. Discrimination between partly homologous molecular systems is easier when some specific protein components are defined as forbidden in the models of the molecular systems lacking them (FIG. 2).

Molecular systems that respect a pre-defined minimal quorum of protein components are identified as complete. The quorum is either the number of mandatory protein components and/or the sum of mandatory and accessory protein components (see the documentation on attributes min_mandatory_genes_required and min_genes_required). Protein components defined as functionally exchangeable are only counted once in the quorum. These protein components can be part of molecular systems defined in other models using the system_ref keyword. Genes encoding protein components that participate in multiple molecular systems of the same type, such as proteins interacting with different instances of a molecular system, are labeled multi_system.

The genetic architecture of the protein components is defined using several attributes. Two protein components are co-localized when their genes are closer than a given number of genes (system-wise parameter inter_gene_max_space, FIG. 2). A protein component defined with the loner attribute does not need to be co-localized with other protein components to be part of a molecular system. One can also specify protein component-specific values of inter_gene_max_space. The system-wise parameter multi_loci allows MacSyFinder to detect model molecular systems encoded by several distant clusters of genes.

Input and Output

The MacSyFinder program receives as input a list of model molecular systems defined in XML files (see above), protein component profiles, command-line parameters and a file with protein sequences in fasta format. The parameters can be specified in the command-line or in a configuration file. Model molecular system and protein component parameters specified in the command-line override model molecular system specifications in the XML files. The presence of a given protein component is determined by similarity search with protein component profiles encoded under the form of hidden Markov models (HMM) using Hmmer [Eddy S R (2011) Accelerated Profile HMM Searches. PLoS Comput Biol 7: e1002195.]. Hits are filtered according to user-defined Hmmer maximal i-evalue and minimal profile coverage of the alignment.

MacSyFinder manages three different types of protein sequence datasets. The unordered dataset lacks information on gene order and genome origin. This mode is useful to study large sequence databanks or metagenomic data. Naturally, in these datasets the notions of co-localization and quorum are not relevant. The unordered replicon dataset includes protein sequences from one single genome. This is useful to analyze unassembled genomes with large numbers of contigs. In this case the notion of quorum is relevant (albeit with certain limitations), but co-localization is not. The ordered replicon dataset includes proteins from one single replicon that are ordered according to the position of the corresponding genes in the genome. This is the most powerful mode and can be used to analyze complete or nearly complete genomes. Another related mode (gembase) requires a specific input file format and allows the analysis of multiple ordered replicons in a single step.

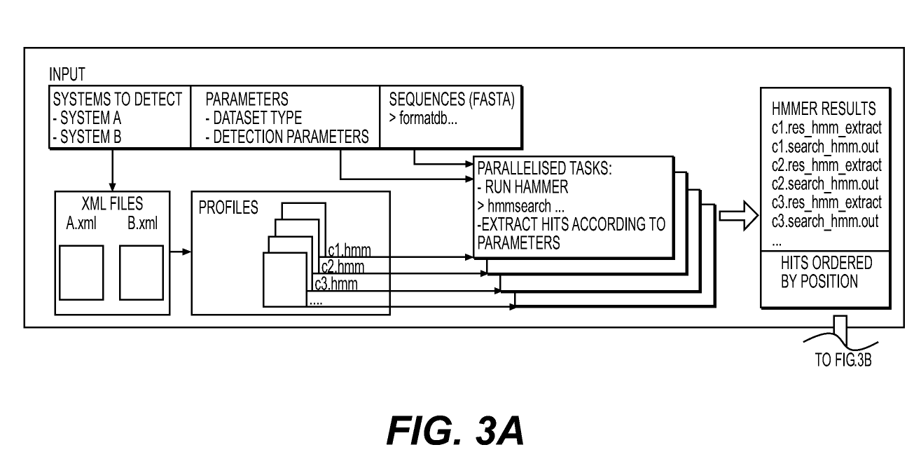

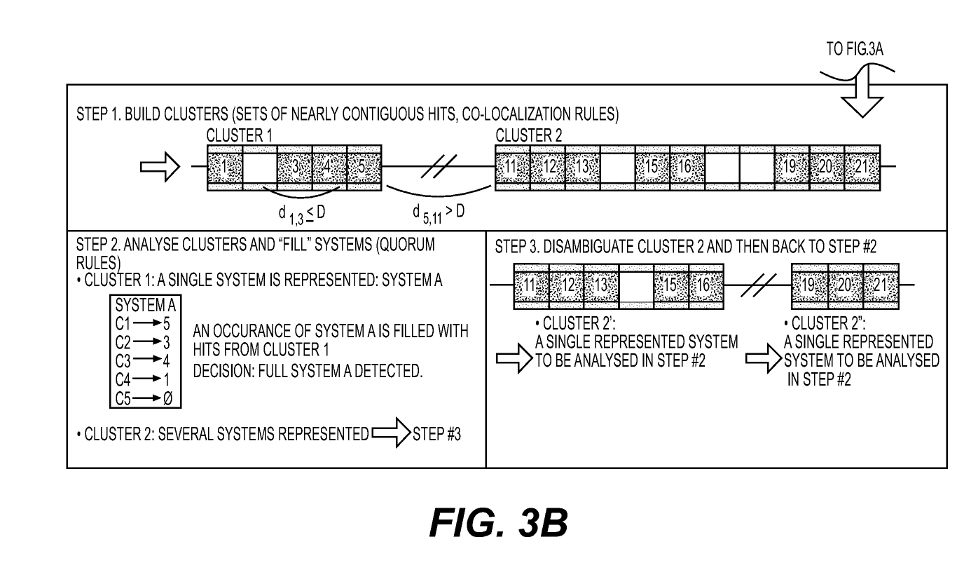

The output of MacSyFinder includes log files, intermediate Hmmer results, the number of detected model molecular systems, and the information on each detected protein component from each instance of the model molecular system. This information is made available in the form of text tables and JSON files. We have built MacSyView, a standalone web-browser application that uses output JSON files to visualize the molecular systems and their genomic context. MacSyView generates exportable SVG files containing views of the detected molecular systems (FIG. 3).

Functioning

The user runs MacSyFinder from the command-line on a protein sequence dataset for a number of model molecular systems of interest. The non-redundant list of protein components to search is extracted from the XML files. Protein components are searched in parallel using Hmmer [Eddy S R (2011) Accelerated Profile HMM Searches. PLoS Comput Biol 7: e1002195.]. If multiple protein component profiles match the same protein, MacSyFinder selects the hit with the highest score. The subsequent steps depend on whether the input dataset is an ordered replicon, an unordered genome or an unordered genomic dataset (e.g., a metagenome).

If the dataset is an ordered replicon, the hit proteins are clustered according to the genetic organization specified in the model molecular system. Clusters including the protein components of a single type of model molecular system are used to fill inventories of “compatible” model molecular systems. If multiple model molecular systems are compatible with the set of protein components in the clusters, then the different candidate model molecular systems are examined. The order of exam is given by decreasing number of protein components shared between the cluster and the compatible model molecular systems. The cluster will be assigned to the first model molecular system in the list that fits its content. A model molecular system is complete if the quorum is respected. When an instance of the model molecular system has components from a single locus, further new occurrences of the same protein components in the cluster are used to produce a novel instance. When a single cluster is not enough to make a complete instance and the multi_loci parameter is turned on, the hits are stored to fill up an instance of the model molecular system encoded by multiple distant loci. Clusters with protein components from multiple model molecular systems are split in sub-clusters containing protein components from a single model molecular system. These sub-clusters are then re-analyzed in terms of their protein components. MacSyFinder can only resolve these complex cases if the protein components of each model molecular system are contiguous, instead of scattered on the cluster.

Unordered sequence datasets cannot be analyzed with the co-localization criteria. Therefore, hits from the similarity searches are directly used to fill inventories of each model molecular system. Model molecular systems are complete if the required quorum is respected. The presence of forbidden protein components is ignored in this mode, even if such occurrences are stored to inform the user. A single model molecular system instance will be filled per system and protein dataset, independently of the number of protein component occurrences found. This is because protein components cannot be individually assigned to particular instances in the absence of the genomic context. Nevertheless, the analysis of the number of identified protein components can be used to estimate the number of instances in the protein dataset.

After a MacSyFinder's run, one might want to visualize graphically the results of the model molecular systems detection. The MacSyView web-browser based application takes as an input the MacSyFinder's output file “results.macsyfinder.json”. Then MacSyView loads the systems and displays a list of them. The user picks a system to visualize by clicking on it in the list. Then the page displaying the results of this system detection opens. It is made of a header, and three panels. The header allows to select another input file, or to go back to the list of systems. It displays information on the system that is being visualized. The first panel shows how the detected molecular system fits the model compliance in terms of protein components content. It gives in boxes the detected numbers of each of the mandatory, accessory or forbidden protein components. A tooltip gives the name of the protein component when the mouse hovers a box. Protein component boxes can be sorted by decreasing number of protein components. The second panel shows the detected molecular system in its genomic context (as transcribed from the input fasta file). Size of protein component boxes is proportional to the length of the corresponding protein, and a scale is plotted. When the mouse hover a box, a tooltip displays information on the corresponding protein component, including scores of the Hmmer hit. This view can be exported as a SVG file for drawing purposes (tools circled in red). The third panel gives full information on the protein components that were selected as being part of the system: Hmmer hits information, native system of the profiles, position of the corresponding proteins in the input fasta file.

Application

Developing a New System's Model

The goal of MacSyFinder is to allow the user to build a biologically meaningful model of the system and use it to query genomic data. The first step of the model building procedure is therefore to use the available knowledge to identify the system components, their frequency and their genetic architecture. The second step is to obtain protein profiles for the components. Profiles can be built with Hmmer on multiple alignments of relevant homologous proteins. When available, these profiles can also be retrieved from public databases such as PFAM or TIGRFAM [Finn R D, Tate J, Mistry J, Coggill P C, Sammut S J, et al. (2008) The Pfam protein families database. Nucleic Acids Res 36: D281-288; Haft D H, Loftus B J, Richardson D L, Yang F, Eisen J A, et al. (2001) TIGRFAMs: a protein family resource for the functional identification of proteins. Nucleic Acids Res 29: 41-43]. Finally, the model should be transcribed into MacSyFinder's XML grammar (see above and FIG. 1 for an example). The third step is to include information about homologous systems to avoid misidentifications. This can be achieved by building simple models and searching for published experimental evidence for the resulting clusters. The use of system-specific profiles and forbidden attributes can be used to build models that facilitate the discrimination between systems (FIG. 2). We strongly recommend building the models by iterating several times on these steps. The fine-tuning of the quorum definitions and genetic architectures can vastly increase the quality of identification of a system. For some systems, only a few instances have been studied. In this case, iteration of the modeling steps provides both more reliable models and a better knowledge of the systems diversity. To exemplify the use of MacSyFinder we built models to identify Cas proteins and classify CRISPR-Cas systems. This is a very typical example of systems that are intensively studied, for which there are many protein profiles in the databases, but no software dedicated to their detection.

Detection and Classification of CRISPR-Cas Systems

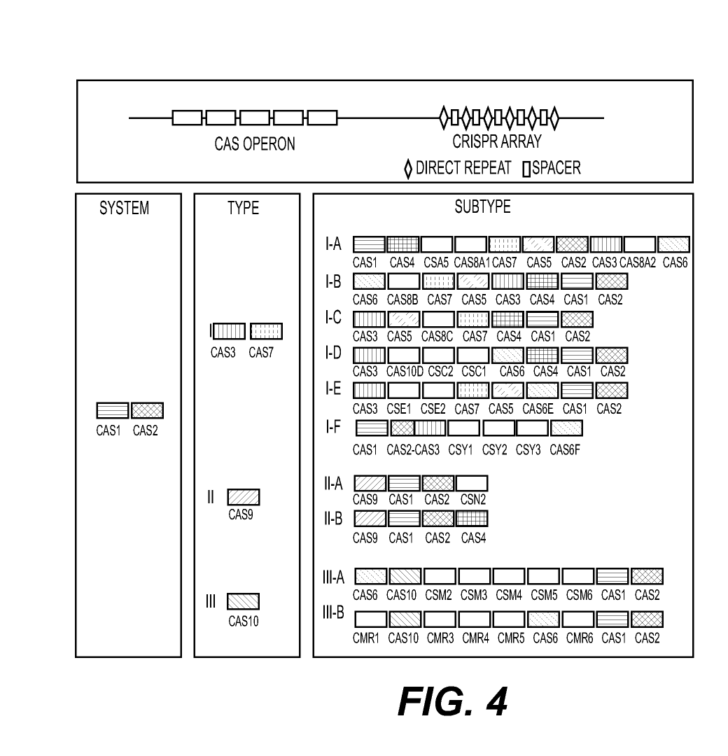

Clustered regularly interspaced short palindromic repeats (CRISPR) arrays and their associated Cas (CRISPR-associated) proteins form the CRISPR-Cas system (FIG. 4).

CRISPR-Cas are sophisticated adaptive immune systems that rely on small RNAs for sequence-specific targeting of foreign nucleic acids such as viruses and plasmids. These invader-specific, adaptive, and heritable systems, are present in many bacteria and most archaea, and are recently becoming important tools in biotechnology [Barrangou R, Marraffini L A (2014) CRISPR-Cas systems: Prokaryotes upgrade to adaptive immunity. Mol Cell 54: 234-244]. The cas operons and the proteins they encode are genetically and functionally very diverse, showing the many biochemical functions they carry to confer resistance against invasive genetic elements. The known cas operons encoded adjacent to the CRISPR arrays have very different sizes, ranging from 3 to 13 genes. Cas protein families are nucleases or helicases with DNA and/or RNA binding domains. A unified classification of CRISPR-Cas systems has been established mostly on the basis of the presence or absence of peculiar Cas protein families, and on the genetic architecture of the cas operon [Makarova K S, Haft D H, Barrangou R, Brouns S J, Charpentier E, et al. (2011) Evolution and classification of the CRISPR-Cas systems. Nat Rev Microbiol 9: 467-477]. Three major types and several subtypes of CRISPR-Cas systems have been described [Makarova K S, Haft D H, Barrangou R, Brouns S J, Charpentier E, et al. (2011) Evolution and classification of the CRISPR-Cas systems. Nat Rev Microbiol 9: 467-477]. cas1 and cas2 universally occur across types and subtypes, whereas cas3, cas7, cas9, and cas10 have been defined as the signature genes for type I, type II, and type III, respectively (FIG. 4). Protein profiles matching most of these Cas protein families are publicly available in the TIGRFAM database [Haft D H, Selengut J, Mongodin E F, Nelson K E (2005) A guild of 45 CRISPR-associated (Cas) protein families and multiple CRISPR/Cas subtypes exist in prokaryotic genomes. PLoS Comput Biol 1: e60; Haft D H, Loftus B J, Richardson D L, Yang F, Eisen J A, et al. (2001) TIGRFAMs: a protein family resource for the functional identification of proteins. Nucleic Acids Res 29: 41-43.]. We used this information to define mandatory, specific, and accessory components, and built models to identify and classify these systems.

General Model and Choice of Parameters

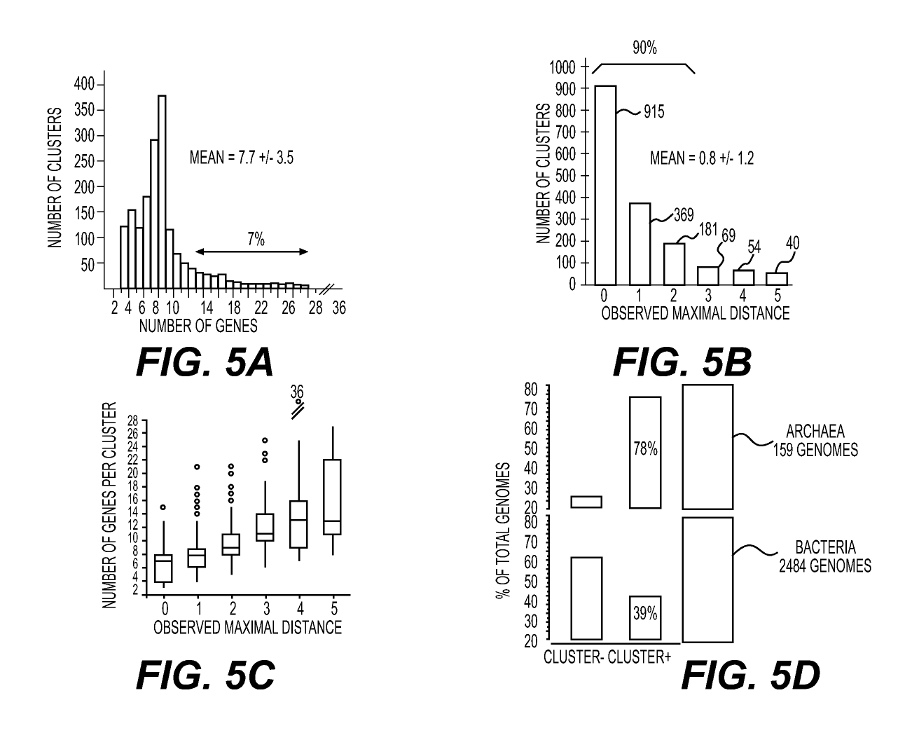

In a first round of analysis, we defined a general model with MacSyFinder to identify all possible clusters of Cas proteins in 2643 prokaryotic genomes. In this general definition, all the CRISPR-Cas-HMM profiles available in TIGRFAM database were used whatever their type or subtype specificity (Table S1). We used first relatively relaxed criteria: all the components were defined as accessory and all clusters with at least 3 different components (min_genes_required=3) distant from at most 5 genes (inter_gene_max_space “D”=5) were retained. With this procedure, we identified 1628 clusters of Cas proteins and could annotate 10663 Cas proteins (i.e., with significant matches to HMM profiles). The total number of genes in the detected clusters ranged from 3 to 36 with an average of 7.7±3.5 genes (FIG. 5A). In these clusters, most of the genes (86%) encode known Cas proteins (i.e., described in the general definition) and 56% of clusters have components strictly contiguous (FIG. 5B). A small fraction of these clusters (7%) are larger than the larger described systems (>13 genes, FIG. 5A), suggesting that the above-mentioned parameters might be too permissive (FIG. 5C). These large clusters might correspond to contiguous or intertwined systems (i.e., chimeric variants). To test this hypothesis, we used different values of D (i.e., D=4, 5, and 6, see Table S2). A more stringent co-localization criterion was applied (D=4), which resulted in a decrease of the overall number of Cas proteins assigned to systems, the subdivision of several previously detected clusters, and the persistence of large clusters. A less stringent criterion (D=6) led to the fusion of several clusters with a small gain of Cas proteins assigned to systems. These results suggest that some of the larger clusters with D=5 correspond to contiguous or intertwined systems. This might be dealt with when using more specific “typing” and “subtyping” models (see below). 88% and 73% of the detected clusters contain respectively a Cas1 or a Cas2 protein, while no constraint was imposed on their presence (accessory proteins in the general definition of the system). Cas clusters are present in 78% of archaeal genomes and 39% of bacterial genomes, which is very similar to previous observations [Staals R H J, Brouns S J J) (2013) Distribution and Mechanism of the Type I CRISPR-Cas Systems. In: Barrangou R, Oost Jvd, editors. CRISPR-Cas Systems-RNA-mediated Adaptive Immunity in Bacteria and Archaea. Berlin Heidelberg: Springer Berlin Heidelberg. pp. 145-169.] (FIG. 5D). We thus extended our analysis by searching for the presence of CRISPR-arrays—markers of functional systems. We found that 88% of the detected systems are close (<5 kb) to a CRISPR-array and that 98% are present in a replicon containing at least one CRISPR-array. Altogether these results suggest that these clusters correspond to CRISPR-Cas systems.

Typing and Subtyping CRISPR-Cas Systems

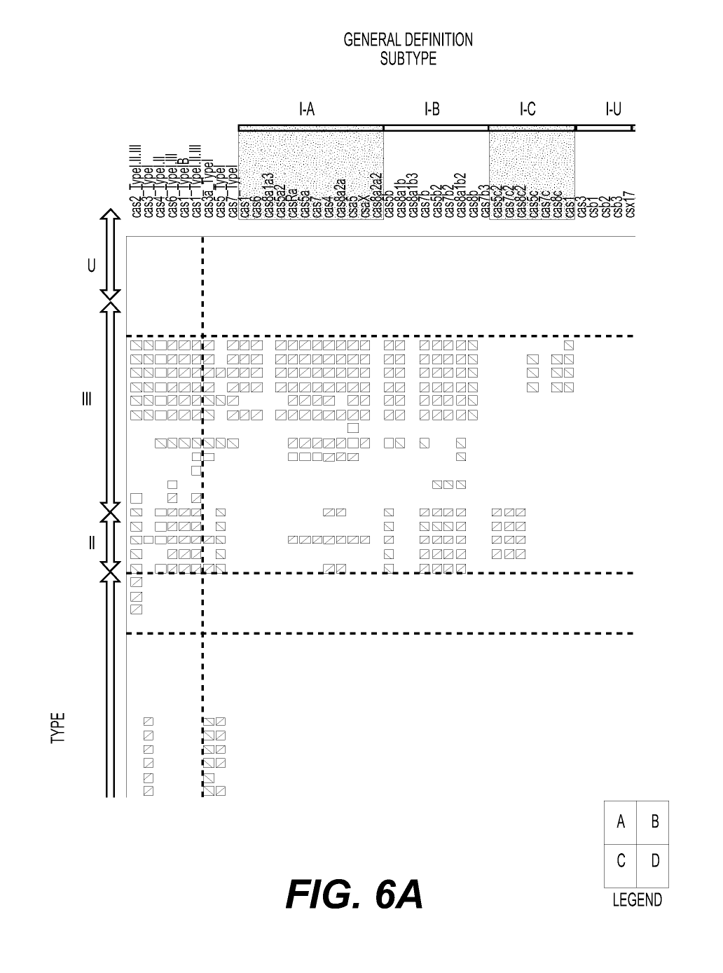

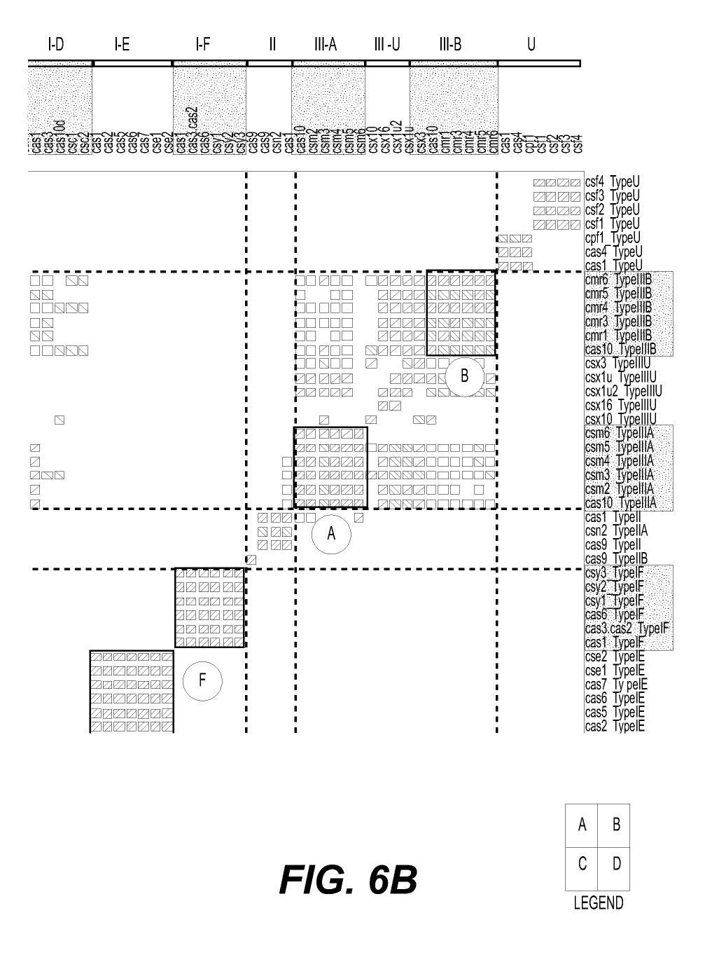

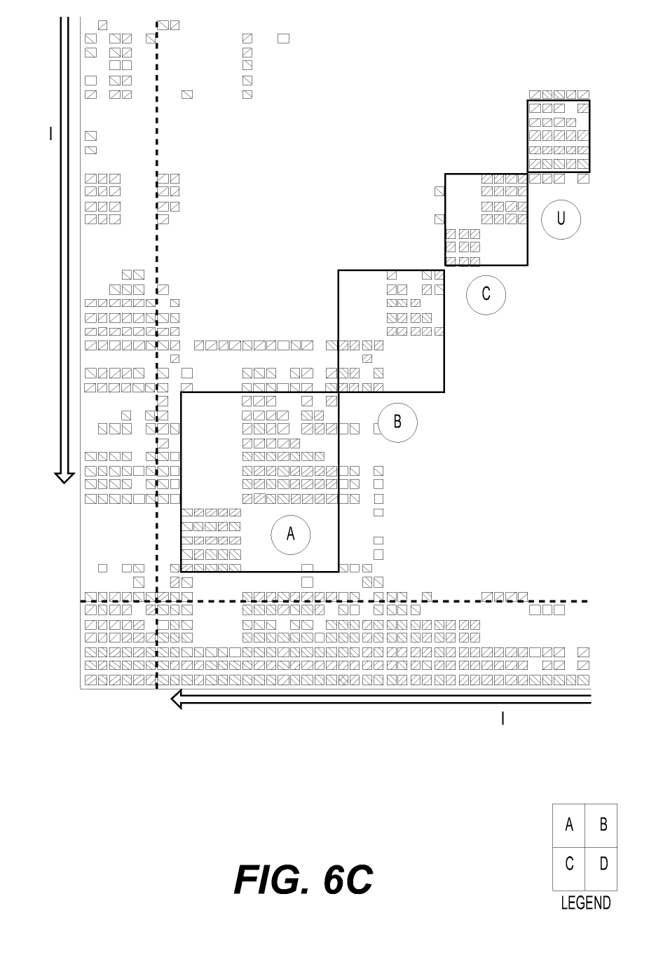

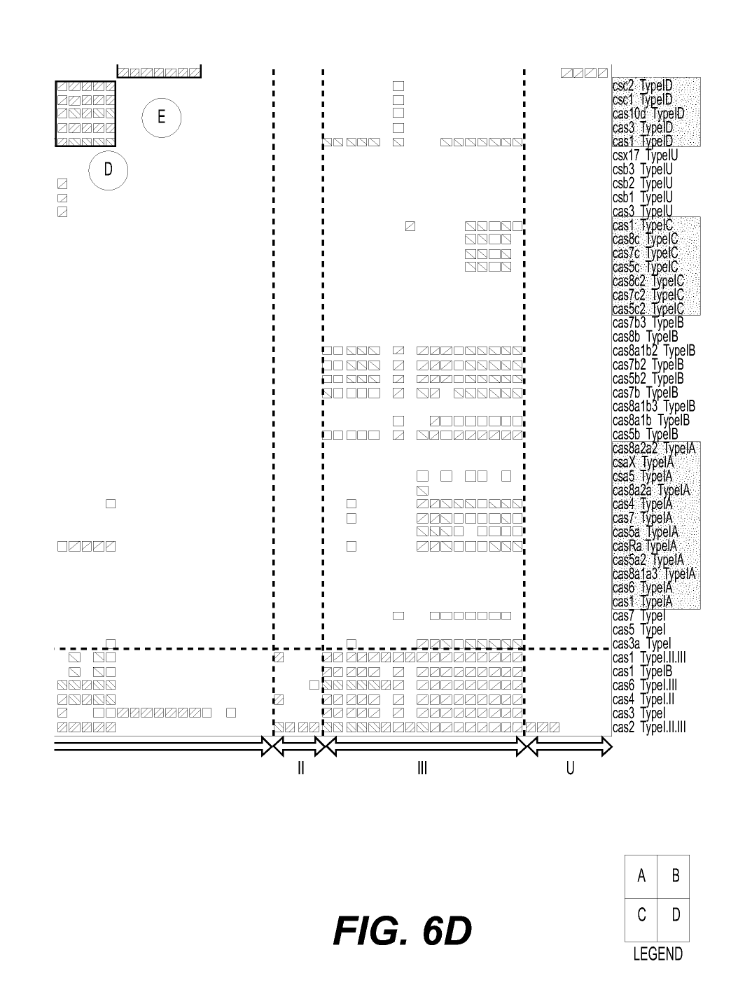

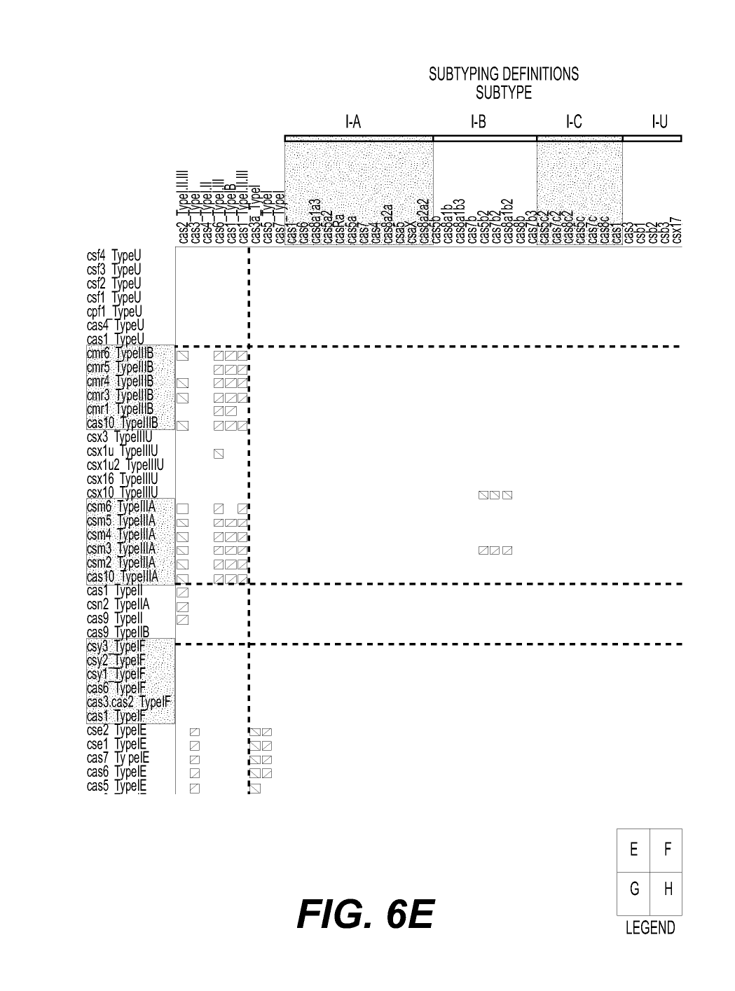

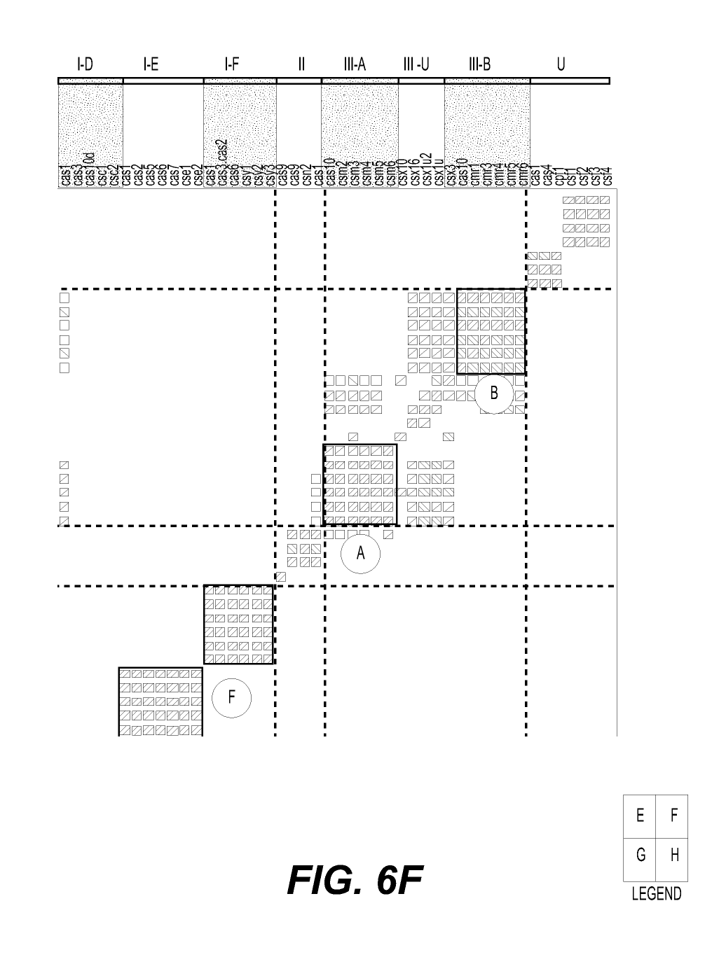

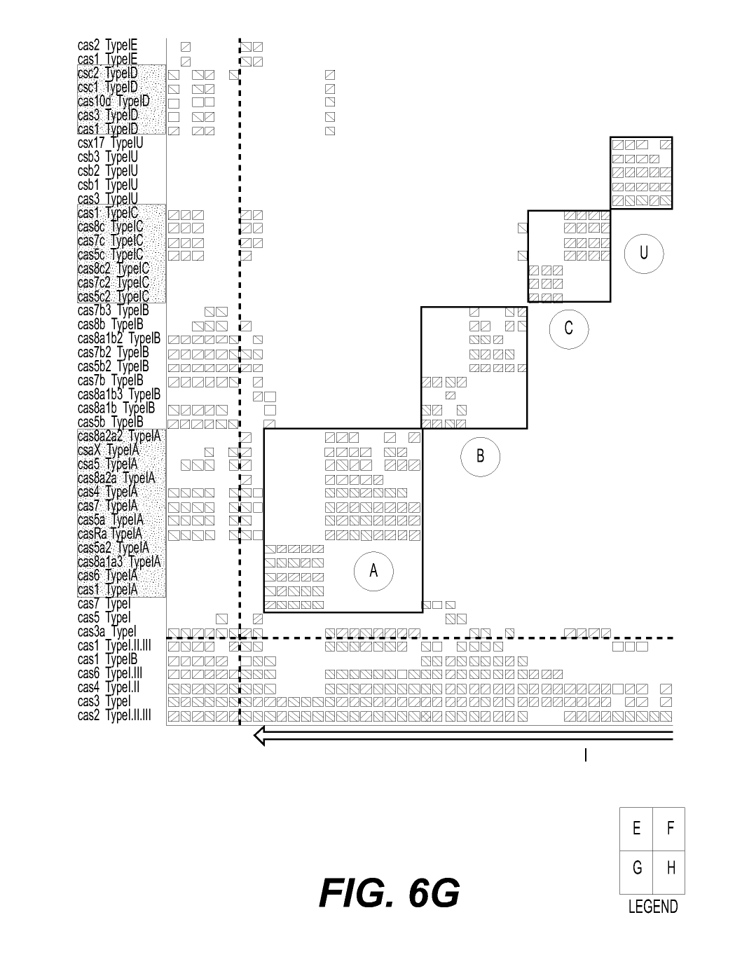

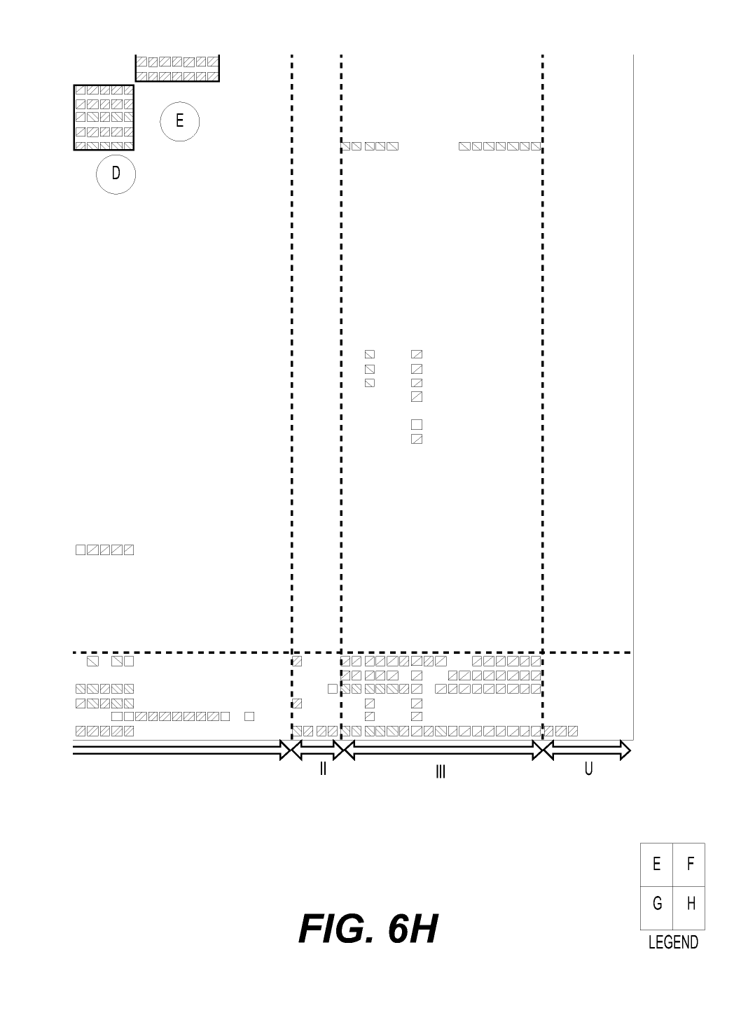

To classify the clusters of Cas proteins with MacSyFinder we designed models for each type and subtype of systems from the pre-existing classification [Makarova K S, Haft D H, Barrangou R, Brouns S J, Charpentier E, et al. (2011) Evolution and classification of the CRISPR-Cas systems. Nat Rev Microbiol 9: 467-477.] (FIG. 4). For this, we first tested the specificity of the 89 available HMMs for a given type and subtype by analyzing the co-occurrence of pairs of Cas proteins in clusters detected with the general model (FIG. 6). The specificity of the 53 HMM profiles constructed by [Haft D H, Selengut J, Mongodin E F, Nelson K E (2005) A guild of 45 CRISPR-associated (Cas) protein families and multiple CRISPR/Cas subtypes exist in prokaryotic genomes. PLoS Comput Biol 1: e60] are consistent with those previously described in [Makarova K S, Haft D H, Barrangou R, Brouns S J, Charpentier E, et al. (2011) Evolution and classification of the CRISPR-Cas systems. Nat Rev Microbiol 9: 467-477.], with a few exceptions. Two profiles previously described as Type I-A specific (TIGR01908 and TIGR02670) profiles, were mostly found in Type I-B. TIGR02582, mostly found in Type III-A, is also found in some Type I-B. TIGR03641 and TIGR04093, characteristic of Type I-B and I-D respectively, are found in some Type III. Profiles of Type III-U are often associated with other systems, especially

Type III-A, III-B and I-B. We found that, as expected, the 36 additional HMM profiles available in TIGRFAM database (Materials and Methods) are more specific to given subtypes. For instance, while the profile TIGR00287 matches Cas1 protein of the three types, new profiles can distinguish the Cas1 protein of the six different subtypes I (FIG. 6). In the final models, all profiles specific to a system were defined as mandatory (signature gene) while all the others were defined as accessory. Because some systems have very similar content and organization (e.g., Type II-A and II-B), profiles to distinguish them are accessory or mandatory in a system, and forbidden in the other (see FIG. 2 for example). Although the types and subtypes have different numbers of genes, we set the min_genes_required parameter to 3, and the inter_gene_max_space parameter to 5 for all models to make the detection as large as possible and comparable with that resulting from the general model. We defined 5 “typing” models and 15 “subtyping” models for cas loci detection and classification.

Using the subtyping models we classed the previously detected Cas clusters, but also divided those corresponding to different contiguous systems (FIG. 6). Thus, among the 1628 Cas clusters, 95% correspond to a single system, 3% to contiguous distinct systems (including the type III-B well known to be associated with other systems-type [Staals R H J, Brouns S J J (2013) Distribution and Mechanism of the Type I CRISPR-Cas Systems. In: Barrangou R, Oost Jvd, editors. CRISPR-Cas Systems-RNA-mediated Adaptive Immunity in Bacteria and Archaea. Berlin Heidelberg: Springer Berlin Heidelberg. pp. 145-169]), the remaining 2% correspond to chimeric variants. Most of the Cas clusters could readily be assigned to proposed types (97%) and subtypes (94%) with our models. The remaining correspond to cas locus with no gene signature, or to chimeric variants (Table S3). Type I systems are more abundant in both bacteria (in ˜31% of the bacterial genomes) and archaea (˜71%), Type II are only found in bacteria, while Type III are more prevalent in archaea (˜38%) (Table 1). These results are consistent with previous analyses [Makarova K S, Haft D H, Barrangou R, Brouns S J, Charpentier E, et al. (2011) Evolution and classification of the CRISPR-Cas systems. Nat Rev Microbiol 9: 467-477.]. Subtypes I-C, I-E and I—F are more commonly found in bacteria, while subtypes I-A, I—B and I-D are frequent in archaea, as previously noted [Staals R H J, Brouns S J J (2013) Distribution and Mechanism of the Type I CRISPR-Cas Systems. In: Barrangou R, Oost Jvd, editors. CRISPR-Cas Systems-RNA-mediated Adaptive Immunity in Bacteria and Archaea. Berlin Heidelberg: Springer Berlin Heidelberg. pp. 145-169]. Our results suggest that the vast majority of the clusters detected with MacSyFinder correspond to CRISPR-Cas systems that can be typed and subtyped using our models.

TABLE 1
Taxonomic distribution of CRISPR-Cas types and sub-types in prokaryotes
expressed in number and percentage of the genomes harboring the systems.

| Typing | Type I | | | | | | | Type II | | | Type III | | | Type U |
|---|---|---|---|---|---|---|---|---|---|---|---|---|---|---|
| Bacteria | 769 (31%) | | | | | | | 177 (7%) | | | 222 (9%) | | | 7 |
| Archaea | 113 (71%) | | | | | | | 0 | | | 60 (38%) | | | 0 |
| Subtyping | I-A | I-B | I-C | I-D | I-E | I-F | I-U | II-A | II-B | II-U | III-A | III-B | III-U | U |
| Bacteria | 16 | 173 | 196 | 31 | 282 | 111 | 47 | 81 | 5 | 93 | 123 | 112 | 3 | 7 |
| | <1% | 7% | 8% | 1% | 11% | 5% | 2% | 3% | <1% | 4% | 5% | 5% | <1% | <1% |
| Archaea | 55 | 48 | 2 | 16 | 5 | 0 | 2 | 0 | 0 | 0 | 28 | 40 | 0 | 0 |
| | 35% | 30% | <1% | 10% | 3% | | 1% | | | | 18% | 25% | | |

### DISCUSSION

The use of MacSyFinder will often involve preliminary steps to model the biological molecular systems of interest. This allows the researcher to produce structured knowledge and is particularly useful when these molecular systems have distinguishable traits, such as a specific genetic architecture. Often there are few studies suggesting the parameters to use in the models. Under these circumstances, one should start with very simple models, e.g., noting all protein components as accessory and using low quorums. The analysis of these results often provides important clues on how to produce more complex and accurate models. For example, by relaxing the criteria of the models to identify type III secretion systems we were recently able to identify a new homologous system in Myxobacteria [Abby S S, Rocha E P (2012) The non-flagellar type III secretion system evolved from the bacterial flagellum and diversified into host-cell adapted systems. PLoS Genet 8: e1002983.]. Modeling can thus lead to new biological findings relative to the systems when the dataset is ordered. It is of more limited interest when using unordered datasets because in this case one cannot produce meaningful instances of the systems. MacSyFinder is designed to use protein profiles and Hmmer to identify protein components of systems instead of the commonly used blast or psi-blast tools. HMM profiles have the advantage, relative to pairwise alignments with a reference expert database, of providing a compressed way to represent a database of homologous sequences, giving increased sensitivity and specificity [Eddy S R (2011) Accelerated Profile HMM Searches. PLoS Comput Biol 7: e1002195]. These profiles are also more stable over time (e.g., iterarive psi-blast searches rely on sequence databank content).

A limitation of MacSyFinder is that it ignores phylogenetic information to put together protein components of molecular systems scattered in a replicon or in unordered datasets. For now, such analyses have to be done separately. In contrast, the preliminary distinction between homologous proteins can often be done using MacSyFinder without the need for lengthy phylogenetic analyses. This works in two steps. First, one must produce a multiple alignment gathering the different families of homologous proteins. This alignment must be divided into sub-alignments according to the different molecular systems, leading to the production of different protein profiles for the different sub-families of homologs. Finally, and as a rule, for a given protein, the best-scoring profile corresponds to the relevant homologous family (see FIG. 2 in [Abby S S, Rocha E P (2012) The non-flagellar type III secretion system evolved from the bacterial flagellum and diversified into host-cell adapted systems. PLoS Genet 8: e1002983]).

Considering MacSyFinder's running time, the limiting step is usually the identification of hits by Hmmer, which is currently very efficient [Eddy S R (2011) Accelerated Profile HMM Searches. PLoS Comput Biol 7: e1002195]. To speed up this step, we included a “parallel” mode to compute and analyse Hmmer hits. This can be very useful when analyzing large protein datasets on multi-cores computers. MacSyFinder and its companion MacSyView are easy to install standalone tools. This is an advantage when it is necessary to keep the data private or when projects are so large that network transfer time is prohibitive. MacSyFinder was built to be simple to use. It is thus ideal for biologists without extensive knowledge of programming or scripting wishing to unravel the diversity of certain molecular systems or to annotate genetic data. Often, bioinformaticians produce methods to identify machineries and would like to easily package them for distribution among biologists. This can be easily done with MacSyFinder via the distribution of XML files and the relevant protein profiles. The “Cas-finder” we present here is a particularly relevant case. At the time we started the project, there was public information available on the protein profiles and on the genetic organization of the systems. We only had to define the models and use them in such a way that we could identify the systems and class them. The result is a highly accurate application to identify cas operon that can be easily distributed.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method for identifying a molecular system that is similar to at least one model molecular system, the method comprising the steps of:
a) establishing an inventory including genetic content, genomic organization and at least one discriminating trait for at least one model molecular system;
b) determining from the inventory(ies) of step a) a non-redundant list of protein components of the at least one model molecular system;
c) associating a protein component profile encoded by a hidden Markov model (HMM) with each non-redundant protein component;
d) providing at least one set of protein sequences obtained from genome data corresponding to a contig of an ordered sequence dataset;
e) similarity searching the set of protein sequences obtain from genome data with the protein component profiles of c);
f) selecting hit proteins that match the searched protein component profiles from among the set of protein sequences obtained from genome data;
g) building clusters using hit proteins selected in step f) according to the genomic organization specified for the model molecular system;
h) selecting clusters including protein components of a single model molecular system according to the genetic content and discriminating traits specified for the model molecular system; and
i) filling inventories of compatible model molecular systems using clusters from step h).

2. The method of claim 1, further comprising the step of visualizing the similar molecular system detected.

3. The method of claim 1, wherein the genome data come from a bacterium, an archaeum, an organelle or a virus.

4. The method of claim 1, wherein at least one set of protein sequences is a set of multiple ordered contigs which organism of origin is identifiable with predefined naming convention of the sequence.

5. The method of claim 1, wherein the at least one discriminating trait is a class of protein components.

6. The method of claim 5, wherein at least one protein component is defined as mandatory.

7. The method of claim 5, wherein at least one protein component is defined as accessory.

8. The method of claim 5, wherein at least one protein component is defined as forbidden.

9. The method of claim 1, wherein the at least one discriminating trait is a protein component attribute.

10. The method of claim 9, wherein at least one protein component is defined as exchangeable.

11. The method of claim 9, wherein at least one protein component is defined as multi-system.

12. The method of claim 1, wherein the at least one discriminating trait is a model molecular system quorum.

13. The method of claim 5, wherein the at least one discriminating trait is a model molecular system quorum corresponding to a minimal number of protein components required.

14. The method of claim 12, wherein the model molecular system quorum corresponds to the maximal number of protein components required.

15. The method of claim 6, wherein the at least one discriminating trait is a model molecular system quorum corresponding to a minimal number of mandatory protein components required in a model molecular system.

16. The method of claim 1, wherein the at least one discriminating trait is a genomic organization attribute.

17. The method of claim 16, wherein at least one protein component is defined as loner.

18. The method of claim 16, wherein at least one model molecular system is defined as multi-loci.

19. The method of claim 1, wherein the genomic organization of the model molecular system is defined by an integer representing the maximal number of protein components without a match between two hits of a cluster.

20. The method of claim 1, wherein the similarity searching of step e) is performed with Hmmer.

21. The method of claim 20, wherein the similarity searching of each of a plurality of sets of protein sequences obtained from genome data is performed in parallel.

22. The method of claim 1, wherein step f) comprises applying selection criteria to the selected hit proteins to identify hit proteins with the highest similarity to the protein component profiles.

23. The method of claim 12, wherein a model molecular system is fully detected when the required quorum is respected.

24. The method of claim 13, wherein a model molecular system is fully detected when the required quorum is respected.

25. The method of claim 15, wherein a model molecular system is fully detected when the required quorum is respected.

26. The method of claim 1, wherein multiple model molecular system candidates are compatible with the set of protein components of a cluster, and further comprising the steps of:
j) classifying model molecular system candidates by decreasing number of protein components shared between the cluster and the compatible model molecular system candidates; and
k) assigning the cluster to the first model molecular system candidate in the list fitting its content.

27. The method of claim 1, wherein a model molecular system has protein components from a single locus and, further new occurrences of the same protein components in a cluster are used to produce a novel molecular system.

28. The method of claim 18, wherein a single cluster is not enough to make a complete model molecular system, and further comprising the steps of:
j) storing hits of the cluster; and
k) filling inventories of model molecular systems defined as multi-loci.

29. The method of claim 1, wherein clusters with protein components from multiple model molecular systems are split-up in sub-clusters containing protein components from a single model molecular system and are re-analyzed in terms of their protein components.

30. A computer-readable storage medium storing instructions of a computer program for implementing the method according to claim 1.
